(19) United States
(12) Patent Application Publication
(10) Pub. No.: US 2003/0156981 A1
(43) Pub. Date: Aug. 21, 2003

(54) Tablets and granules for treating water

(76) Inventor: Dudley John Mills, (US)

Correspondence Address: Wilson & Ham, PMB: 348, 2530 Berryessa Road, San Jose, CA, 95132, US

(21) Appl. No.: 10/370,678

(22) Filed: Feb. 18, 2003

(30) Foreign Application Priority Data
Feb. 18, 2002 (AU) PS0570

(51) Int. Cl. C02F 1/50

(52) U.S. Cl. 422/37; 422/28; 424/408; 424/489; 424/600

(57) ABSTRACT

Tablet and granules for treatment of pool water comprise at least one water-soluble sanitizer and at least one lanthanide compound (other than phosphate) compacted or otherwise formed into a physically coherent body. A matrix, carrier or binder adapted to dissolve and/or disintegrate over time in pool water may also be used. The sanitizer and lanthanide are dispersed within the tablet or granule so that, upon dissolution or disintegration of the tablet or granule, the lanthanide compound will be released. A method involves placing the tablet or granules in the flow of water to the pool filter so that, as the tablet or granule dissolves, the sanitizer is dissolved into the pool water and the lanthanide is carried into the filter where it is retained as a particulate solid that is effective in removing phosphate from pool water circulating in the filter and from whence it can be removed by backwashing.

### CLAIM FOR PRIORITY

This application claims foreign priority benefits under Title 35, USC 119 of Australian Patent Application number PS0570, filed Feb. 18, 2002.

### TECHNICAL FIELD

This invention relates to tablets and granules for treating water to mitigate both bacterial and algal growth. It is also concerned with methods of forming such tablets and granules and with methods of their use, as well as to the composition of the tablets and granules themselves. The tablets and granules of the invention may include other agents intended to effect secondary treatments, such as water clarification and/or the regulation of pH, scale or oils. Such agents are known in the art and are not disclosed herein.

The materials and methods of the invention are particularly applicable to the treatment of water in swimming pools, ponds, fountains, cooling towers and the like where water is circulated by pumps through filters and where bacterial and/or growth may pose a health hazard to humans or where algal growth is unsightly or is likely to impair the operation of filters, fountains, cooling towers and the like.

The term ‘tablets’ is used herein to generically encompass coherent solid, or compacted particulate, products of a variety of shapes and sizes that may be formed as sticks, blocks, balls, pucks, rods, tubes, small or large biscuits, hollow floats of various forms, etc.

The term ‘granules’ is used herein to generically encompass un-compacted particulate products of a variety of shapes and sizes that may be formed as grains.

### BACKGROUND

Water treatment tablets and granules for the slow release of chlorine into swimming pools are well known in the art. The chlorine-releasing compounds are typically chlorinated cyanurates or calcium hypochlorite formulated to dissolve slowly and to release chlorine into the pool to control bacterial growth. Once dissolved, chlorinated cyanurates regulate the release of chlorine into the water so that it is not lost at an undue rate in sunshine or in the presence of metals such as copper and iron. The problem of excessive chlorine loss due to these factors with compounds such as calcium hypochlorite is well documented in the art.

In swimming pools, it is usual for water treatment tablets to be placed in an inlet screen prior to the filter or in eroders placed after the filter so that they will dissolve or break up over a period of time, releasing active agents contained therein into the flow of water into or out of the filter. Such inlet screens include skimmer boxes, lint baskets and the like. Placing tablets in the inlet screen or eroders ensures that the agents are dispersed and mixed in the pool by water discharged from the filter into the pool. Granular materials are, more commonly, cast over the surface of the swimming pool water so that they will dissolve or break up more quickly than the tablets.

Manufacturer's instructions for the use of chlorinating tablets and granules are generally designed to ensure that the concentration of available chlorine in the pool is maintained at between 0.6 and 3.0 ppm. At this concentration, chlorine is an effective sanitizer; that is, it is effective in controlling bacterial growth to levels that are relatively safe for humans.

However, at below about 5 ppm, chlorine is not considered to be effective in controlling algal growth in pools. Pool owners are therefore expected to keep algae at acceptable levels by normal pool maintenance; that is, by scrubbing algal film from the bottom and walls of the pool and regularly pumping, filtering and back-washing the algae to waste. When these maintenance tasks become burdensome, many pool owners add algaecide products (which are typically organic compounds, such as quaternary amines) to suppress algal growth. The algaecides cannot be effectively included in chlorinating pool tablets because of adverse reactions with chlorine (or other sanitizing compounds such as peroxysulphate). Whilst inorganic algaecides (usually silver or copper compounds, such as copper sulphate) are sometimes included in tablets containing chlorinated compounds and are generally immune from adverse chlorine reactions, they are not very effective and pool owners need to continue scrubbing and filtering to control algae, albeit at a marginally lower level of intensity. Moreover, silver and copper compounds can introduce problems like staining.

### BRIEF SUMMARY OF THE INVENTION

From one aspect, the invention comprises a physically coherent tablet or granule for use in the treatment of water, comprising a physical mixture of a water-soluble sanitizing compound and a lanthanide compound (other than a phosphate), the tablet or granule being adapted to dissolve or disintegrate over time in water so that the sanitizing compound and the lanthanide compound will be released therefrom.

From another one aspect, the invention comprises a tablet or granule for use in the treatment of water, comprising: a water-soluble sanitizing compound, a lanthanide compound (other than a phosphate) and a solid or paste-like matrix, carrier or binder adapted to dissolve or disintegrate over time in water, the sanitizing compound and the lanthanide compound being dispersed within the matrix such that, upon dissolution or disintegration of the matrix, the sanitizing compound and the lanthanide compound will be released therefrom.

The lanthanide compound can be incorporated as fine sparingly-soluble particles, or it can be incorporated as a soluble lanthanide species that forms fine insoluble lanthanide-containing particles upon contact with pool water or upon contact with the filter media. When a tablet containing a soluble lanthanide compound (for example, lanthanum chloride) is placed in the inlet current of a pool filter, the fine lanthanide particles (for example, lanthanum carbonate and lanthanum phosphate) will form in the water enroute to the filter and in the filter itself so as to be retained therein. The matrix of the tablet or granules may include a flocculating or a gel-forming material capable of binding or agglomerating the fine lanthanide particles as they are released or form so that they are more efficiently retained in the filter. [See our prior Australian patent No. 675512.] The flocculating or gel-forming material also serves to prevent the lanthanide particles from dispersing freely in the pool as the matrix disintegrates or dissolves, and thus avoiding the pool becoming cloudy.

If desired, a stabilizing agent—such as cyanuric acid or one of its salts—for the chlorine sanitizer may be included in the tablet, as taught in the art. However, a stabilizer will not generally be necessary when using a stabilized sanitizer such as a chlorinated cyanurate.

In our prior Australian patent No. 675512, we showed that problematic algal growth in swimming pools was closely related to phosphate concentration in the pool water, phosphate being an important nutrient for algae. We also showed that particulate lanthanides could be used to sequester phosphate from the pool water and so reduce the algae problem. Since phosphates are important nutrients for algae in the pool environment, the lack of phosphate nutrient limits algal growth and weakens the algae that are present, increasing their sensitivity to the mildly algaecidal activity of dilute sanitizers such as chlorine. Thus, the addition of a lanthanide to tablets or granules capable of maintaining recommended concentrations of chlorine in a pool can effect the control of both bacterial and algal growth in normal pools, provided the lanthanide is sufficient to hold pool phosphate concentrations below about 100 ppb. Furthermore, because of the weakened nutritional state of the algae in the pool, the addition of a mild copper-based algaecide to the tablet will have an enhanced impact on algae in the pool.

When a tablet formed in accordance with the invention dissolves or disintegrates in the current of water flowing to a filter (e.g., the inlet screen or ‘skimmer box’ of a swimming pool), the dissolved sanitizer and stabilizer (if present) are drawn through the filter and discharged for mixture in the pool as normal. However, the particulate lanthanide material that is introduced into, or that forms in situ within, the filter is substantially retained in the filter bed so that, as water is circulated past such particles, phosphate is sequestered from the water. In due course, the lanthanide will be converted to the phosphate form and will be no longer active but, since the lanthanide phosphate will be particulate and substantially insoluble in pool water it will be retained in the filter. However, additional active lanthanide particles will keep being loaded into the filter as new tablets added to the inlet screen dissolve or disintegrate. From time to time, the filter will be backwashed in the normal manner and the exhausted lanthanide material in the filter will be removed.

From another aspect, the present invention comprises a method of treating pool water to mitigate both bacterial and algal growth therein, the method comprising the steps of:

contacting a tablet or granule with the water to effect the dissolution and/or disintegration thereof to gradually release (i) a lanthanide compound adapted to sequester dissolved phosphate from the pool water by the formation of sparingly soluble lanthanide phosphate to thereby mitigate algal growth through nutrient removal, and (ii), a soluble sanitizing compound having bactericidal properties to thereby mitigate bacterial growth within the pool water, and

removing the lanthanum phosphate from the pool.

The tablet or granule may be contacted with the pool water by simply casting or placing it into the pool water or by retaining it within a screen, floating eroder, or the like container that is placed in contact with the pool water. Where a pool filter is used, it will be convenient to place the tablet or granule in the water current entering or leaving the filter so as to facilitate dissolution or disintegration of the tablet or granule. The sparingly soluble lanthanide phosphate formed then may be removed from the pool water by filtration. This will be facilitated if the tablet or granule is placed in the inlet screen of the filter. The use of sanitizers, such as calcium hypochlorite, that aid the formation of flocs containing the lanthanide phosphate will also facilitate the removal of the lanthanum phosphate particles by filtration.

Thus, from another aspect, the present invention comprises a method of treating water in a pool to mitigate both bacterial and algal growth, comprising the steps of:

circulating the water through a filter to create an inwards water current from the pool into the filter,

retaining within the inwards current a slow-release tablet containing a soluble sanitizer and a lanthanide compound (other than a phosphate) so that the tablet will dissolve and/or disintegrate to thereby release the sanitizer and the lanthanide compound into said current, the sanitizer being dissolved in the pool water and the lanthanide compound forming sparingly soluble lanthanum carbonate or lanthanum phosphate particles by reaction of that compound with carbonate or phosphate within the pool water,

retaining the lanthanum particles within the filter while continuing to circulate pool water through the filter, and

removing the lanthanum particles from the filter by backwashing.

It will be seen that, since the tablet and method of this invention effect bacterial and algal control through separate and different mechanisms, the opportunity to optimize each mechanism separately exists. Bacterial control is effected by maintaining the concentration of a dissolved bactericide in the pool water above some minimum level (e.g., 1 ppm for chlorine), as is conventional. Algal control is effected by using a lanthanide compound to remove an essential algal nutrient from the water ‘at leisure’, not by attempting to maintain the instantaneous concentration of a dissolved algaecide in the water above some arbitrary level. The addition of an excess of lanthanide to the pool filter has no adverse affect on the quality of the pool water or on the health of pool users, since such compounds are insoluble and not bioactive.

Sanitizers suitable for use in the tablets of the invention may be selected from chlorinating and brominating substances such as alkali metal and alkaline earth metal hypochlorites, substituted and un-substituted chlorinated hydantoins, substituted and un-substituted chlorinated isocyanurates and isocyanuric acids, substituted and un-substituted chlorinated glycolurils, substituted and un-substituted chlorinated oxazolidinones and imidazolidinones and like chlorinated substances.

Lanthanides suitable for use in the tablets of the invention may be selected from compounds of the cations of chemical elements yttrium, lanthanides (which include lanthanum and are also known as ‘rare earths’) and zirconium. The compounds of the chemical element lanthanum are preferred due to their low cost and relatively high geochemical abundance. The single oxidation state of La³⁺ in water at normal temperatures and pressures is also an important advantage. The compounds may include other cations such as alkali metal, alkaline earth, aluminium cations and the like. The preferred anions of the compounds are sulphate, chloride, hypochlorite, chlorite, chlorate, perchlorate, bromide, hypobromite, bromate, perbromate, borate, nitrate, hydroxide, bicarbonate and carbonate. The compound may contain mixtures of cations and anions and water. For example, hydrated (sodium, lithium) aluminium lanthanum (hydroxy-carbonate, chloride). Phosphate is preferably substantially absent for best initial phosphate sequestration. Other anions which complex strongly with the cations such as EDTA and the like are also preferably substantially absent as they reduce the rate and mass of phosphate sequestration. The use of soluble hydrated lanthanides like lanthanum sulphate together with a flocculating substance like aluminium chloride has the surprising benefit of reducing the dissolution rate of the tablets by forming a thin film of gel like material around to tablet.

Given that the optimal concentration of chlorine in pool water is about 1 ppm, that the sequestering of phosphate by lanthanides is approximately stoichiometric, and that phosphate concentrations in normal pools are seldom more than 500 ppb—and optimally below 50 ppb—I have found that ratios of between 20:1 and 1:1 chlorine to lanthanum in tablets to be optimal. Ratios closer to 10:1 in slowly dissolving tablets are preferred for well-maintained pools in which phosphate levels are below 100 ppb. Ratios closer to 1:1 in rapidly dissolving tablets are preferred in pools that have phosphate concentrations near or above about 1000 ppb. Generally, larger proportions of lanthanide compounds tend to result in more rapidly dissolving tablets.

The rate of tablet dissolution can also be controlled by the choice of appropriate chlorinating compounds, matrices or binders. The chlorinating compounds that are preferred are chlorinated isocyanuric acids; chlorinated hydantoins are less preferred. Matrices or binders suitable for use in the tablets of the invention include unchlorinated isocyanuric acids, fatty acids, glycolurils, hydantoins, aluminium hydroxide chloride or sulphate, borax or borates and soluble salts. If the chlorinating agent is chlorinated isocyanuric acids, a slightly acid hydrated mixture of aluminium chloride or sulphate and lanthanum chloride or sulphate is preferred as the matrix. If the chlorinating agent is a chlorinated hydantoin, the more neutral hydroxides, bicarbonates and carbonates are preferred. Addition of halogenated glycolurils and halogenated hydantoins will tend to slow the rate of dissolution. They contribute to the halogen assay of the product and prolong the active life of the halogens. Soaps are less preferred because they produce minor quantities of scum and fats in some waters.

The matrix may include various organic and in-organic clarifiers or floccing agents, the most preferred being-aluminium chloride and aluminium sulphate. These compounds are moderately effective phosphate sequesterants in their own right, where the concentration of phosphate in the pool water exceeds a few ppm. However only impracticably large amounts of soluble or insoluble aluminium salts will reduce the concentration of phosphate to a few ppb as is desired to secure negligible algal growth. However, I have found that the aluminium salts have beneficial effects in maintaining the reactivity of the lanthanide cations towards phosphate and in flocculating the otherwise fine unreacted and reacted lanthanide compounds.

If desired, protective compounds such as cyanuric acid may be added to the tablet and granule formulation to protect the dissolved chlorinating compound against too rapid break down and/or to extend the life of active chlorine in the pool water in sunny conditions. It will be appreciated that the expected rate of loss of active chlorine in the pool will influence the selected ratio of chlorine to lanthanide compounds in the tablets and granules. Thus, the ratio of sanitizer (e.g., chlorine) to lanthanum in a tablet can vary widely.

Tablets can be formed by compacting the selected mixture into the desired shape, baking it at an elevated temperature (usually below 100° C.) until at least partial fusion occurs, then suddenly cooling the mixture to reduce the generation of large crystals in the tablet. In addition, pressing agents or lubricants, such as soaps or boric acid, can be added to assist initial compaction of the mixture.

The rate of dissolution of a pool tablet will, of course, depend upon the ratio of mass to surface area, as well as upon the nature of the matrix. Tablets with more stable—slower release—matrices will generally be of smaller size and can be added in larger numbers to the inlet screen. Also, by staging the addition of smaller tablets to maintain a given number—e.g., five—visible in the inlet screen, a more uniform release of sanitizer and phosphate capture can be achieved. To achieve a more uniform release rate from large tablets, they can be given a layered construction where the solubility of the matrix varies.

It will be appreciated that use of the tablets and granules of this invention is not confined to swimming pools, but they are applicable to any confined water system that is exposed to sunlight and therefore likely to have problems with algal growth. In many of these other systems, such as water cooling systems, storage tanks, grey-water treatment pools and the like, water clarity is not of great importance and filtration circuits may not be required. The tablets and methods of the invention are also applicable in or to such systems. That is, the tablets and granules of the invention can be simply added to a body of water and allowed to dissolve, with or without the use of stirrers or water circulation.

It is desirable that the tablets and granules disclosed herein be packaged so as to preclude the entry of moisture during storage, since moisture can result in the generation of gas. For example, where chlorinated sanitizers are employed, chlorine gas can be generated if the tablets or granules become moist. As it is often difficult to totally exclude moisture during the formation of the tablet or granules, it is also desirable to ensure that the package allows the egress of gas that may be generated in storage, even where the ingress of external moisture is excluded. The use of rigid canisters with ill-fitting lids that permit the egress of gas under pressure but restrict contact with surrounding air are known in the art, but do allow ‘breathing’ of the canister with changing barometric pressure and, therefore, the ingress of atmospheric moisture.

From another aspect, the present invention comprises packaged tablets or granules of the type disclosed herein, characterized in that it is or they are enclosed by a flexible plastic membrane and in that one-way valve means is provided to permit the egress of gas under pressure from within the package but to inhibit the ingress of atmospheric air into the package. Convenient packages are tubular sheaths, blister packs or a vacuum-formed open-topped flanged containers. These may be formed from polyethylene, PVC or other film that is substantially impermeable to air and moisture and is resistant to chlorine gas. A thin flexible membrane closure may be used to close the filled container, being attached to the container by a releasable contact adhesive or by permanent bonding (as by heat-sealing, for example). If a releasable adhesive is employed, the closure and container themselves can form the one-way valve means, since they can separate to vent internal gas pressure but be pressed together to inhibit ingress of air when atmospheric pressure is greater than the container pressure. Where the closure is securely attached to the container, as by heat-sealing, the valve means can be formed by leaving a gap in the seal so that internal gas pressure can be vented through the gap and so that, upon excess external air pressure, the membrane outward of the gap will be pressed onto the container, again inhibiting ingress of air into the container. Alternatively, portion of the container or closure may have a vent hole that is covered by a flap that operates to vent internal pressure but close with external pressure, as described. It is also envisaged that tablets and granules can be packed in such containers under partial vacuum. This has the advantage that atmospheric pressure will hold the contents rigid and reduce the likelihood of breakage or fragmentation during transport. Indeed, if the tablet product is not stored for significant lengths of time, it is likely that it will still be under some vacuum when opened for use.

### BRIEF DESCRIPTION OF THE SEVERAL VIEWS OF THE DRAWINGS

FIG. 1 is a perspective view of an open-topped container suitable for accommodating a tablet.

FIG. 2 is a perspective view of the container of FIG. 1 into which a tablet has been cast or placed.

FIG. 3 is a perspective view of the loaded container of FIG. 2 to which a closure membrane fitted with a flap-valve has been applied.

FIG. 4 is a sectional elevation of the container of FIG. 3 taken on section line IV-IV of FIG. 3.

FIG. 5 is a perspective view of a container filled with a tablet and closed by a membrane that is attached by a releasable adhesive.

FIG. 6 is a sectional elevation of the container of FIG. 5 taken on section line V-V indicated in FIG. 5.

### EXAMPLES

1 Base Mixture

A dry paste was formed by mixing the following components together at 80° C. in the following proportions by weight:

Sanitizer: chlorinated isocyanuric acid, 1,000 g,

Lanthanide: lanthanum sulphate, 500 g,

Matrix: aluminum sulphate, 75 g,

2 Tablets

A die of 75 mm diameter and about 75 mm deep was employed. It was held at about 80° C. and, prior to being loaded with the basic mix, was sprayed with the boric acid lubricant. It was then charged with 200 g of the basic paste mix, which was also held at about 80° C. A piston was then forced into the die under a load of 10 t to compress the mix in the die. The tablet thus formed was then ejected from the die and cooled with dry air to quickly reduce its temperature to ambient. It was robust, being difficult to break by hand, approximately 25 mm long and had a diameter of 75 mm.

Three of the above tablets were placed in the skimmer box of an 80,000 I swimming pool with the filter pump running, the temperature of the pool water being about 25° C., the chlorine concentration being about 0.5 ppm and the phosphate concentration being about 300 ppb. After about 8 hours of pumping and circulation, the pool chlorine concentration had risen to 1.5 ppm, and the phosphate concentration in the pool water was lowered to about 200 ppb. The tablet had reduced in weight to 80 g. For the purposes of the trial, the pool was not used for swimming during this period.

3 Granules

The base of the die in the above example was replaced with one having 24 2.5 mm diameter holes. The die was charged as before and the piston loaded to extrude lengths of the mixture, which were air dried at ambient temperature before being tumbled and sieved to produce granules of about 2.5 mm diameter and 2.5 mm length. 200 g of these granules were then loaded into plastic tubes of about 30 mm diameter and 140 mm long, the ends of the tubes being heat-sealed.

The granules formed as above described were used by cutting one end off a plastic tube and pouring the contents into the skimmer box of the pool so that all the granules were drawn immediately into the pool filter. This resulted in a sudden noticeable increase in chlorine concentration of about 1.5 ppm within the pool and a gradual reduction in phosphate concentration of about 120 ppb over a period of 8 hours.

3 Two-Component Tablet

The base mixture of Example 1 was made, except that the aluminum sulphate was matrix was omitted. This mixture was heated to 100° C. and compressed into a tablet as in Example 2 under a force of 12 t. The resultant tablet was ejected and cooled by dry air to ambient temperature, whereupon it was immediately sealed in a blister pack under a dry nitrogen atmosphere to ensure the exclusion of additional oxygen and moisture.

Tablets of Example 4 were used in exactly the same manner as those of Example 2. However, they were found to disintegrate at rate that was about 30% higher than the tablets of Example 2.

4 Packaging

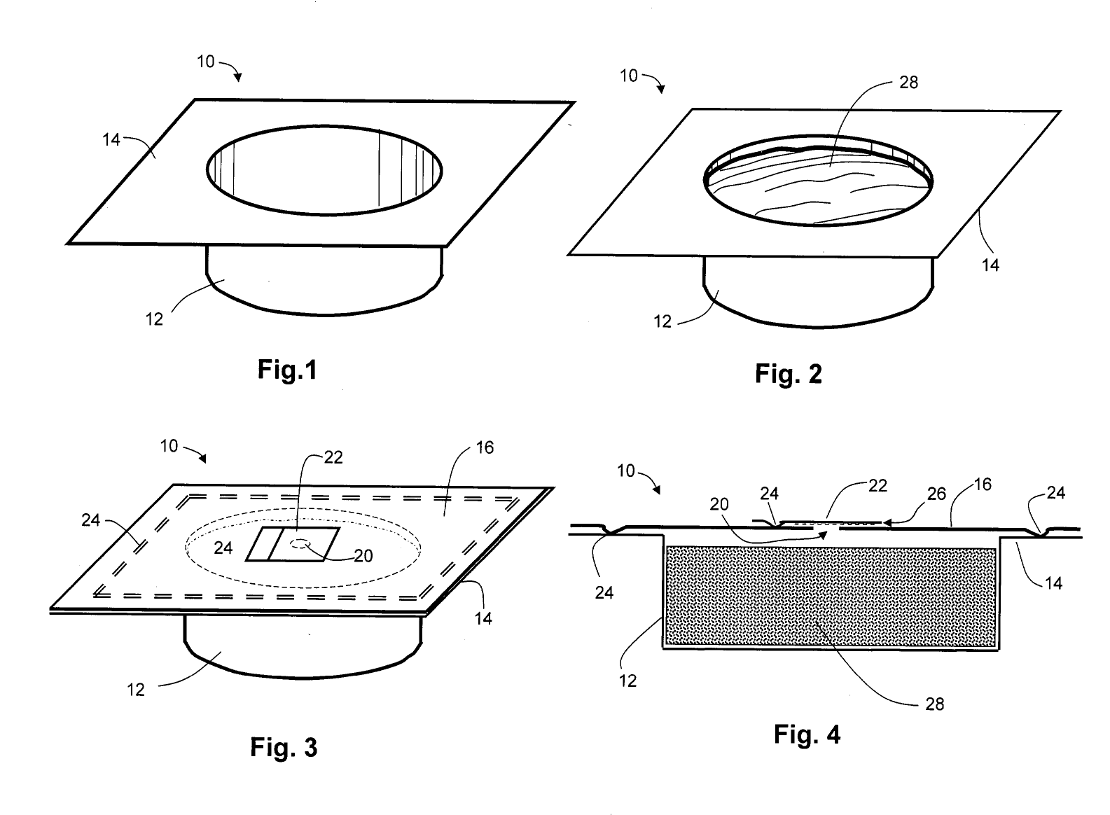

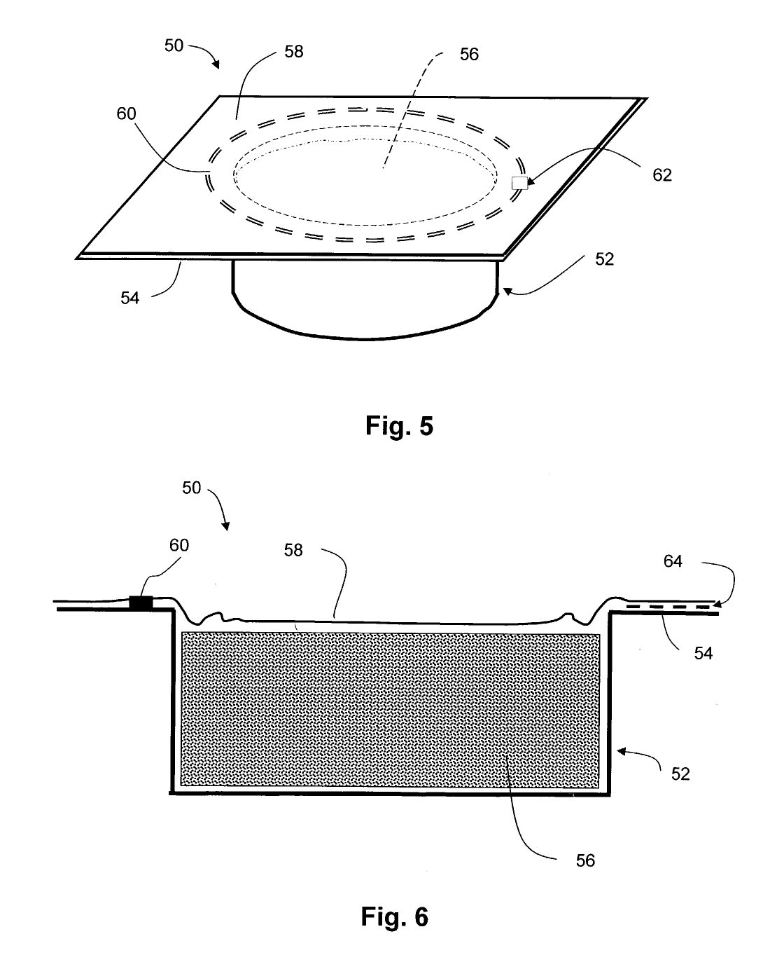

The packaging of the tablets of this example will now be described with reference to the accompanying drawings, in which FIGS. 1-4 illustrate a first example of a suitable package and FIGS. 5-6 illustrate a second example.

The package 10 of the first example comprises a cup-like container 12 having a peripheral radial flange 14 to which a closure membrane 16 is secured by a heat-seal seam 18. A hole 20 is formed in the center of closure 16 and is covered by a flexible flap 22, which is attached to closure 16 by a heal-seal seam 24 along one edge. If desired, flap 22 may be releasably adhered to the outside of closure 16 by the use of a grease-like sealing-aid or a releasable adhesive, indicated at 26.

The components of the package can be formed from PVC. If desired, the package may be sealed under partial vacuum, as is known in the packaging art. In this case, a tablet 28, formed as above described, is shown located in container 12.

It has been found that dry tablets packaged in this way can be stored for up to three months before internal pressure is sufficient to lift flap 22. Thereafter, storage life of the tablet appears to be indefinite and at least in excess of one year.

The second packaging example, shown in FIGS. 5 and 6, comprises a package 50 having a container 52 with a peripheral flange 54. Container 52 is filled with a cast or preformed tablet 56 and closed by a thin flexible membrane closure 58. Closure 58 can be lightly attached around flange 54 using a sealant grease or releasable adhesive. However, because of the danger of the closure being displaced during handling or transport, it is preferred to securely attach closure 58 to flange 54 by a permanent seal or seam, indicated at 60, which is not complete but has a narrow vent gap 62. To assist sealing of the closure against air ingress, a sealant grease or releasable adhesive, indicated at 64, is applied between the flange 54 and closure 58 outward of and in the vicinity of gap 60.

What is claimed is:

1 A physically coherent tablet or granule for use in the treatment of water, comprising a physical mixture of a water-soluble sanitizing compound and a lanthanide compound (other than a phosphate), the tablet or granule being adapted to dissolve or disintegrate over time in water so that the sanitizing compound and the lanthanide compound will be released therefrom.

2 A tablet or granule according to claim 1 including a solid or paste-like matrix, carrier or binder adapted to dissolve or disintegrate over time in water to effect the delayed release of said compounds into the pool water, the sanitizing compound and the lanthanide compound being dispersed within the matrix (chlorinated cyanurate or lanthanide compound can be the matrix; carrier or binder not needed).

3 A tablet or granule according to claim 1 wherein the lanthanide compound is incorporated in the tablet as fine sparingly-insoluble particles adapted to be released into the pool water as the tablet dissolves or disintegrates.

4 A tablet or granule according to claim 1 wherein the lanthanide compound is water soluble so that, as it is released, it will form fine, sparingly-soluble lanthanide-containing particles upon contact with pool water or with pool filter media.

5 A tablet or granule for use in the treatment of swimming pool and like waters, comprising:
a solid water-soluble sanitizing compound,
a solid lanthanide compound (other than a phosphate), said lanthanide compound being substantially non-bioactive with respect to algae and bacteria, and
a solid or paste-like matrix, carrier or binder adapted to dissolve or disintegrate over time in water,
the sanitizing compound and the lanthanide compound being dispersed within the matrix such that, upon gradual dissolution or disintegration of the matrix, the lanthanide compound will be gradually released therefrom.

6 A tablet or granule according to claim 1 wherein said lanthanide compound is selected from the group comprising yttrium, the lanthanides and zirconium.

7 A tablet or granule according to claim 6 wherein said lanthanide compound is a compound of lanthanum.

8 A tablet or granule according to claim 6 wherein said lanthanide compound includes one or more other cations selected from the group comprising alkali metal, alkaline earth, and aluminium.

9 A tablet or granule according to claim 6 wherein the lanthanide compound includes at least one anions selected from the group comprising; sulphate, chloride, hypochlorite, chlorite, chlorate, perchlorate, bromide, hypobromite, bromate, perbromate, borate, nitrate, hydroxide, bicarbonate and carbonate.

10 A tablet or granule according to claim 6 wherein the lanthahide compound includes hydrated (sodium, lithium) aluminium lanthanum (hydroxy-carbonate, chloride).

11 A tablet or granule according to claim 5 wherein the lanthanum compound comprises lanthanum sulphate and wherein said matrix comprises aluminium chloride whereby, upon immersion in pool water, a layer of gel forms around the tablet or granule to thereby reduce dissolution rate.

12 A tablet or granule according to claim 5 wherein the matrix includes a flocculating or a gel-forming material capable of binding or agglomerating the lanthanide particles as they are released or form, whereby said bound or agglomerated particles are adapted for retention by filter media.

13 A tablet or granule according to claim 1 wherein said sanitizing compound is selected from:
chlorinating and brominating substances, including alkali metal and alkaline earth metal hypochlorites,
substituted and un-substituted chlorinated hydantoins,
substituted and un-substituted chlorinated isocyanurates and isocyanuric acids,
substituted and un-substituted chlorinated glycolurils,
substituted and un-substituted chlorinated oxazolidinones, and
imidazolidinones and like chlorinated substances.

14 A tablet or granule according to claim 13 wherein:
said sanitizing compound is a non-cyanurate compound, and
a water-soluble stabilizing agent is included in the tablet or granule, said agent being adapted to chemically stabilize said non-cyanurate compound after dissolution in pool water so as to regulate the release of chlorine therefrom.

15 A tablet or granule according to claim 1 wherein the ratio of chlorine to lanthanide is between 20:1 and 1:1

16 A tablet or granule according to claim 1 and suitable for use in treating pools have a phosphate concentration of less than 200 ppb, characterized in that the ratio of chlorine to lanthanide is between 12:1 and 8:1.

17 A tablet or granule according to claim 1 and suitable for use in treating pools have a phosphate concentration of greater than 500 ppb, characterized in that the ratio of chlorine to lanthanide is between 2:1 and 0.5:1

18 A tablet according to claim 5 wherein the matrix is selected from unchlorinated isocyanuric acids, fatty acids, glycolurils, hydantoins, aluminium hydroxide chloride or sulphate, borax or borates and soluble salts.

19 A tablet according to claim 2 wherein the sanitizing agent is a chlorinated isocyanuric acid and wherein the matrix is a slightly acid hydrated mixture of aluminium chloride or sulphate and lanthanum chloride or sulphate.

20 A tablet according to claim 2 wherein the sanitizing agent is a chlorinated hydantoin and wherein the matrix is selected from hydroxides, bicarbonates and carbonates.

21 A method of treating pool water to mitigate both bacterial and algal growth therein, the method comprising the steps of:
contacting a tablet or granule with the water to effect the dissolution and/or disintegration thereof to gradually release (i) a lanthanide compound adapted to sequester dissolved phosphate from the pool water by the formation of sparingly soluble lanthide phosphate to thereby mitigate algal growth through nutrient removal, and (ii), a soluble sanitizing compound having bactericidal properties to thereby mitigate bacterial growth within the pool water, and
removing the lanthanum phosphate from the pool.

22 A method according to claim 21 comprising the step of contacting the tablet or granule with the pool water by casting or placing it into the pool water or by retaining it within a screen, floating eroder, or the like container that is placed in contact with the pool water.

23 A method of treating water in a pool to mitigate both bacterial and algal growth, comprising the steps of:
circulating the water through a filter to create an inwards water current from the pool into the filter,
retaining within the inwards current a slow-release tablet containing a soluble sanitizer and a lanthanide compound (other than a phosphate) so that the tablet will dissolve and/or disintegrate to thereby release the sanitizer and the lanthanide compound into said current, the sanitizer being dissolved in the pool water and the lanthanide compound forming sparingly soluble lanthanum carbonate or lanthanum phosphate particles by reaction of that compound with carbonate or phosphate within the pool water,
retaining the lanthanum particles within the filter while continuing to circulate pool water through the filter, and
removing the lanthanide particles from the filter by backwashing.

24 A package comprising a container containing a table or granules formed in accordance with claim 1, the container being substantially sealed against the ingress of atmospheric air during storage but having flap-like vent means for releasing super-atmospheric gas pressure generated within the container by said tablet or granules during storage.
